(19) United States
(12) Patent Application Publication
(10) Pub. No.: US 2016/0139589 A1
(43) Pub. Date: May 19, 2016

(54) THERMAL MITIGATION BASED ON EVENT COUNTER

(71) Applicant: QUALCOMM Incorporated, San Diego, CA (US)

(72) Inventors: Rajit CHANDRA, San Diego, CA (US); Mohamed Waleed ALLAM, San Diego, CA (US)

(21) Appl. No.: 14/546,836

(22) Filed: Nov. 18, 2014

(51) Int. Cl. G05B 19/406

(52) U.S. Cl. CPC G05B 19/406; G05B 2219/49219

(57) ABSTRACT

An apparatus is provided. The apparatus includes a plurality of counters configured to count electrical activity switching events of cores, a first circuit configured to predict a temperature at a location based on counts of at least one of the plurality of counters, and a second circuit configured to schedule a thermal mitigation function based on the predicted temperature. A method for scheduling thermal mitigation functions is provided. The method includes counting electrical activity switching events, predicting a temperature at a location based on the counting of the electrical activity switching events, and scheduling a thermal mitigation function based on the predicted temperature. Another apparatus is provided. The apparatus includes means for counting electrical activity switching events, means for predicting a temperature at a location based on a count of the electrical activity switching events, and means for scheduling a thermal mitigation function based on the predicted temperature.

### BACKGROUND

1. Field

The disclosure relates to apparatuses with thermal management functions and, in particular, to electronic apparatuses and integrated circuits (ICs) with thermal mitigation functions scheduled based on predicted temperatures and/or power activities.

2. Background

Increasingly, thermal management is becoming an issue in operating ICs. For example, wireless communication technologies and devices (e.g., cellular phones, tablets, laptops, etc.) have grown in popularity and use over the past several years. These electronic apparatuses have grown in complexity and now commonly include multiple processors (e.g., baseband processor and application processor) and other resources that allow the users to execute complex and power intensive software applications (e.g., music players, web browsers, video streaming applications, etc.). To meet the increasing performance demand, the processors has increased in complexity and operate in frequencies in the gigahertz range. As a result, substantial heat may be produced while operating the processors.

The heat generated by the processors may affect the performance and the reliability of the device. For example, the performance of an IC degrades when operating in high temperature. Thus, one design challenge is providing the thermal mitigation functions to manage the heat issue.

### SUMMARY

Aspects of a method for scheduling thermal mitigation functions are disclosed. The method includes counting electrical activity switching events, predicting a temperature at a location based on the counting of the electrical activity switching events, and scheduling a thermal mitigation function based on the predicted temperature.

Aspects of an apparatus are disclosed. The apparatus includes a plurality of counters configured to count electrical activity switching events of cores, a first circuit configured to predict a temperature at a location based on counts of at least one of the plurality of counters, and a second circuit configured to schedule a thermal mitigation function based on the predicted temperature.

Aspects of another apparatus are provided. The apparatus includes means for counting electrical activity switching events, means for predicting a temperature at a location based on a count of the electrical activity switching events, and means for scheduling a thermal mitigation function based on the predicted temperature.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 is a diagram of an exemplary embodiment processor with counters for counting electrical activity switching events.

FIG. 2 is a diagrams illustrating the effects of duty cycles of power activities on the on-die temperatures.

FIG. 3 is a block diagram of an exemplary thermal management module.

FIG. 4 is a flow chart of an exemplary embodiment for scheduling a thermal mitigation function.

FIG. 5 is another flow chart of an exemplary embodiment for scheduling a thermal mitigation function.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of the disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. Various apparatus and methods presented throughout this disclosure may be implemented in various forms of hardware. By way of example, any of these apparatus or methods, either alone or in combination, may be implemented as an integrated circuit, or as part of an integrated circuit. The integrated circuit may be an end product, such as a microprocessor, a digital signal processor (DSP), an application specific integrated circuit (ASIC), programmable logic, or any other suitable integrated circuit. Alternatively, the integrated circuit may be integrated with other chips, discrete circuit elements, and/or other components as part of either an intermediate product, such as a motherboard, or an end product.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus or method does not require that all embodiments of the invention include the described components, structure, features, functionality, processes, advantages, benefits, or modes of operation.

The terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As used herein, two elements can be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of the stated features, integers, steps, operations, elements, and/or components, but do not preclude the presence or addition of one or more other features, integers, steps, operations, elements, components, and/or groups thereof.

Various aspects of apparatuses and methods for scheduling thermal mitigation functions based on predicted temperatures are presented with respect to a processor for wireless communication. However, as those skilled in the art will readily appreciate, aspects and applications of the disclosure may not be limited thereto. For example, the features presented may be applicable to other ICs besides a processor and applicable to functions beyond wireless communication. Accordingly, all references to a specific application for the presented apparatus or method are intended only to illustrate exemplary aspects of the apparatus or method with the understanding that such aspects may have a wide differential of applications.

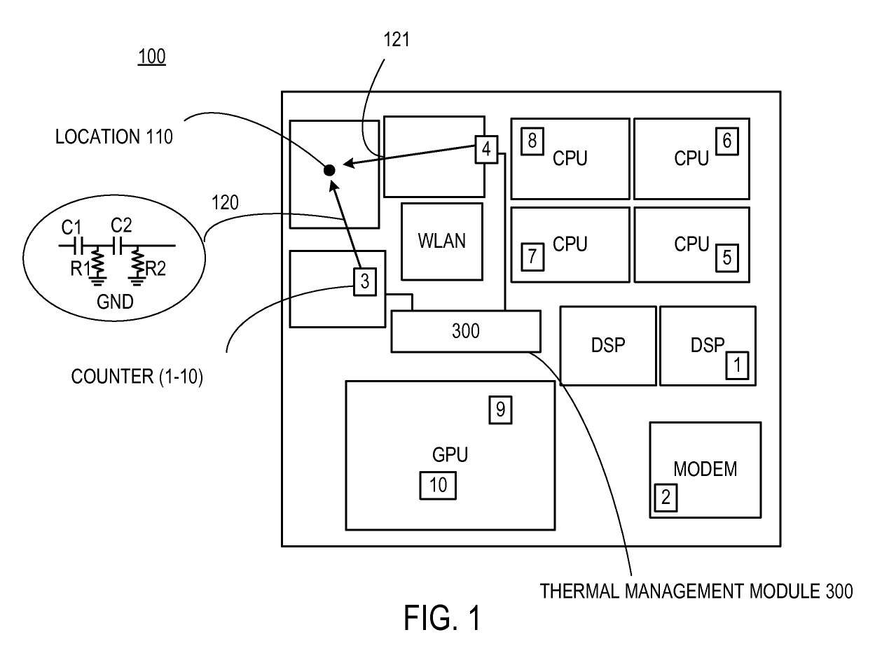

FIG. 1 is a diagram of an exemplary embodiment processor with counters for counting electrical activity switching events. In one configuration, an exemplary embodiment apparatus may be a cell phone incorporating the processor 100 or the processor 100. The processor 100 may be a processor for wireless communication, such as an integrated application and baseband processor for a cell phone. The processor 100 includes various cores or blocks of circuits, such as graphic processor unit (GPU), digital signal processors (DSP), modem, central processing units (CPU), and a wireless local area network or WLAN block. A core may be, for example, a collection of circuits. The processor 100 also includes various counters (1-10). Each of the counters may be associated with a core. For example, counter 1 is associated with the DSP core, and counters 9 and 10 are associated with the GPU core. Each of the counters is configured to count electrical activity switching events. For example, an electrical activity switching event may be an operation of a core (e.g., turning ON or turning OFF). In one implementation, a power activity duty cycle of a core (e.g., DSP, GPU, etc.) may correspond to a count of the counters (1-10) in the time period.

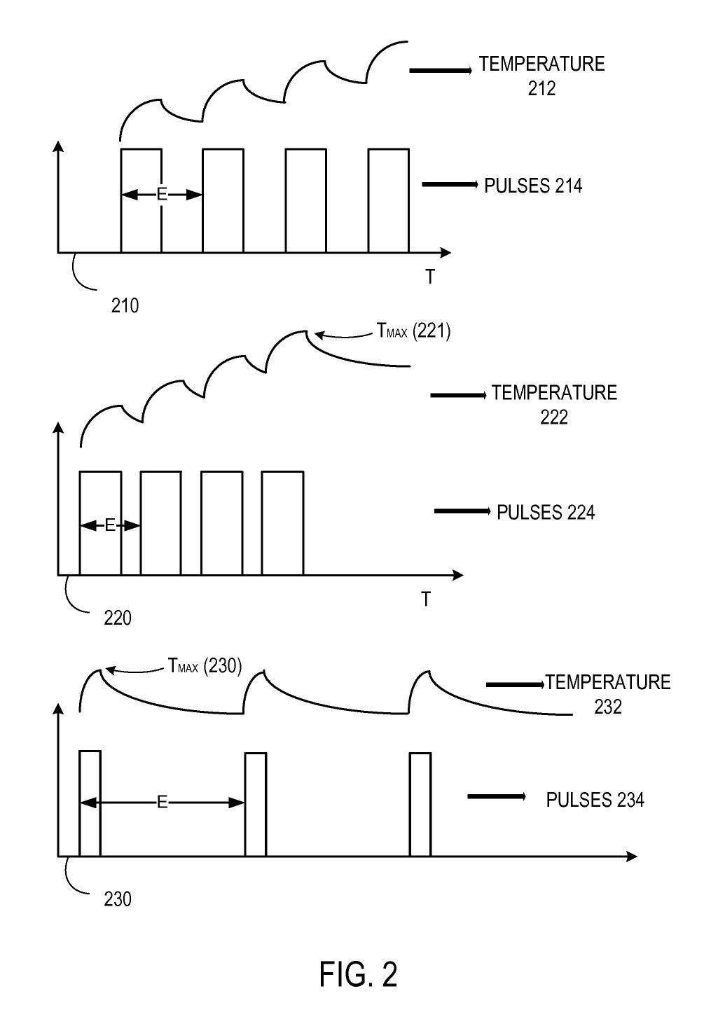

FIG. 2 is a diagrams illustrating the effects of duty cycles of power activities on the on-die temperatures. The diagram 210 illustrates a case where the duty cycle is 50%. In a time period T, power activities include a series of four pulses 214. Each of the pulses 214 may be an electrical activity switching event (e.g., a core switching ON and OFF). Each of the pulses 214 is in an electrical/power activity period E. In the diagram 210, the ON period of the pulses 214 is the same as the OFF period (giving a duty cycle of 50%). In a case that the electrical/power activity period E is shorter than a thermal constant, the temperature 212 rises steadily due to the series of pulses 214.

Diagram 220 illustrates a case where the duty cycle is greater than 50%. Each of the pulse 224 has an on period that is greater than 50% of the electrical/power activity period E. In this case, the temperature 222 rises more rapidly than the temperature 212 of the diagram 210, until reaching a maximum T_{MAX} (221).

Diagram 230 illustrates a case where the duty cycle is less than 50%. Each of the pulse 224 has an on period that is less than 50% of the electrical/power activity period E. In this case, the temperature 232 rises slower than the temperature 212 and the temperature 222. In operation, the processor 100 may vary among these and other sequences of power activities. In another example, the magnitudes of the powers and the duty cycles of a core may vary for each electrical/power activity period E and impact the temperature of the core. Thus, the temperature prediction may take these factors into account to achieve desired accuracy.

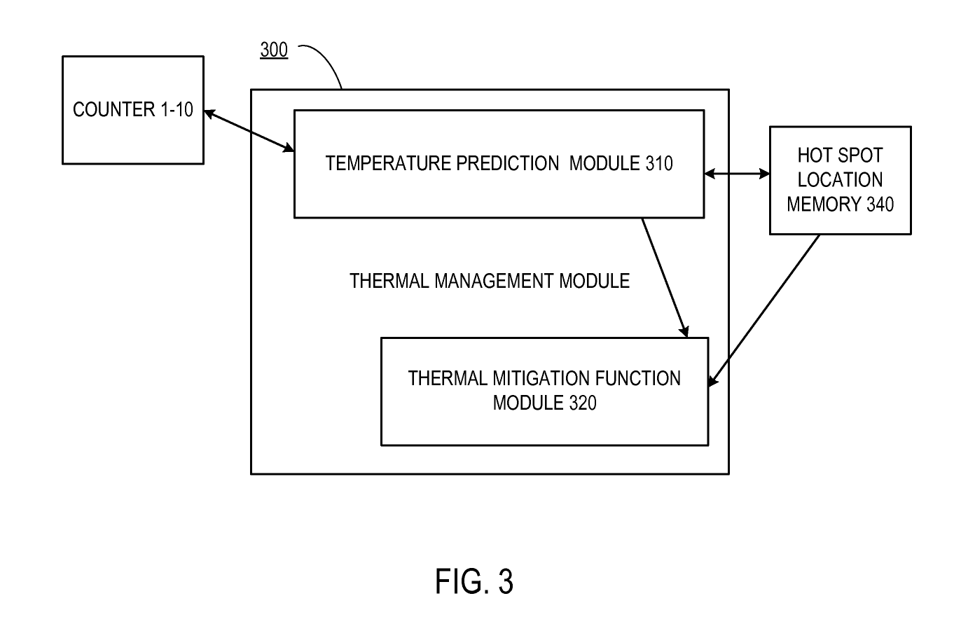

FIG. 3 is a block diagram of an exemplary thermal management module. The thermal management module 300 includes a temperature prediction module 310 and a thermal mitigation function module 320. These modules may include circuits, processor systems, software executing on the processor systems, or combinations thereof. These modules may include circuits for generating the signals for the functions described infra or signal lines carrying those signals. These modules may be part of processor 100 or external to the processor 100. In one example, theses modules may include instructions executed by the CPUs of the processor 100.

By way of example, a module, or any portion of a module, or any combination of modules may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In one implementation, the temperature prediction module 310 evaluates counts from counters 1-10 and determined a plurality of power pulses of a core in consecutive intervals. The temperature prediction module 310 may further processes the power pulses pair-wise across a time interval of interest T. A time period T may be, for example, a period needed by the thermal mitigation function module 320 to counteract a hot spot. At each pair-wise processing, a multiplication factor M is cumulatively modified based on the pulse interval and magnitude. At the end of the time interval T, the energy calculated is modified using M and then averaged over T to calculate the thermal profile.

In one example, the temperature prediction module 310 may determine the plurality of power pulses of the core utilizing the following algorithm:

(1) Set counter j=1. Set indices i,k to function block domain and clock domain, respectively. Set index n:

n×(1/fₖ)<=T,
where T is a period for evaluating the power for temperature prediction and fₖ is the clock frequency. The index n may be user-provided or set to default.

(2) If k×n<T then go to step 3, else go to step 10. Step 10 calculates the power for temperature prediction.

(3) Set clock counter R2=n. Set activity counter R1 to 0.

(4) Count down R2 to 0. Increment activity counter R1 each time an electrical switching event is registered.

(5) If R2=0, then read activity counter R1. The step sets up calculation per each n counts of clock.

(6) Compute α=R1 value/n. The step computes an average activity count over n clock cycles

(7) Compute P_{i,j}=Cᵢ×Vᵢ²×αᵢ×fₖ. The capacitance value may be from a non-volatile memory on the device (e.g., a fuse set or read-only-memory (ROM)). The voltage V may be from a voltage sensor. The subscript i represents the i^{th} sub-block or functional unit, and j represents the sample number of the power collected in the j^{th} interval as defined by n. The subscript k represents the clock domain.

(8) Compute and store (n/f)×P_{i,j} in registers. The step computes energy count per n activities.

(9) If j=1 then go to step 2, else increment j. Set the adjusting factor M=1.

(10) Compute the adjusting factor M for accounting for input power duty cycle based on following method:

P(T)=Σₙ₌₁^{N}(Pₙ×Δtₙ)×M)/T,
wherein Δtₙ=tₙ−tₙ₋₁, and t₀=0.
   The adjusting factor M is calculated as follows:

If (Pₙ₊₁=Pₙ); then Mₙ₊₁=Mₙ;

If (Pₙ₊₁<Pₙ); then Mₙ₊₁=Mₙ+|Pₙ₊₁−Pₙ|×(e^{-Δt}^{ₙ}^{/T});

If (Pₙ₊₁<Pₙ); then Mₙ₊₁=Mₙ+|Pₙ₊₁−Pₙ|×[1−(e^{-Δt}^{ₙ}^{/T})];

M(Σⱼ₌₁^{N}Mⱼ))//N

In one implementation, the processor 100 may include various temperature sensors on chip, and the temperatures tₙ may be based on the measured temperatures or predicted temperatures. The algorithm may be implemented by, e.g., ROM filters on the processor 100. In another implementation, the algorithm may be store on the processor 100 as a look-up table using the activity count as a variable. These implementations of the algorithm may reduce the time to predict the temperature.

In one implementation, the determined power P(T) may be summed with a leakage power. The leakage power may be determined based on process parameters and voltage. The process parameters may be characterized and save in a non-volatile memory on the processor 100. The voltage may be determined from a voltage sensor. The temperature prediction module 310 may predict a temperature based on a sum of the determined power P(T) and the leakage power.

Various features of the exemplary embodiment, e.g., flowing from the algorithm above, are presented below. Counters 1-10 are configured to count electrical activity switching events of multiple cores (e.g., DSP, GPU, etc.). A first circuit, such as the temperature prediction module 310, is configured to predict a temperature at a location based on counts of at least one of counters (1-10) (activity counter R1 in the algorithm).

The temperature prediction module 310 may predict a temperature based on the determined power P(T), which is determined by a convolution function (e.g., see step 10 of the algorithm above). Schemes to predict temperature from power are known in the art, once the power is determined. An example of such scheme is to utilize a linear scale and a thermal dissipation constant. In another configuration, the temperature prediction module 310 may predict the temperature based on a duty cycle of the core. As demonstrated by the algorithm, the duty cycle may be based on the counts of a counter (activity counter R1). In another configuration, the temperature prediction module 310 may predict the temperature based on a sequence of powers (the sequence of Pₙ). Moreover, each Pₙ in the sequence may be modulated by a factor M, which is based on a previous power in the sequence (e.g., the modulation factor Mₙ₊₁ for the power Pₙ₊₁ is based on the previous power in the sequence Pₙ).

In one implementation, the temperature prediction module 310 may predict temperatures at locations based on other predicted temperatures. Referring to FIG. 1, the temperature prediction module 310 may predict a temperature at a location 110, which is at a distance from the location of the counter 3 (FIG. 1). For example, the temperature prediction module 310 may predict temperatures at location 110 based on the predicted temperature (which is based on the counter 3) or a measured temperature from a temperature sensor and based on a thermal resistor-capacitor (RC) circuit model (120). In one example, the thermal RC circuit model 120 may be analogous to an electrical RC model and includes thermal capacitors C1 and C2 and thermal resistors R1 and R2. In one example, the thermal resistances and the thermal capacitances of the processor 100 may be intrinsic properties of the silicon, package materials, and dimensions of the IC. In one implementation, the thermal capacitors C1 and C2 and thermal resistors R1 and R2 may be obtained from die level simulation or system measurements. Such models may be stored in a non-volatile memory (such as ROM) on the processor 100 or off-chip. In one example, the thermal RC circuit model 120 maybe stored as part of an operation system running the processor 100. In one implementation, the temperature prediction module 310 may predict the on-die temperatures for any location on the processor 100, including the location 110, via the thermal RC circuit model 120, the counters 1-10, and/or the temperature sensors.

In one example, temperature prediction module 310 may predict temperatures of location 110 based on the predicted temperature (which is based on counter 4) or a measured temperature from a temperature sensor via the thermal RC circuit model 121, in addition to the predicted temperature based on counter 3 (or a measured temperature from a temperature sensor). In one implementation, the thermal profile at the location 110 may be a linear superposition of the predicted or measured temperatures from the various heat sources (such as the predicted temperatures based on counters 3 and 4 or measured temperatures from the temperature sensors). For example, a predicted temperature at the location 110 may be a sum of a predicted temperature based on counter 3 (via the thermal RC circuit model 120) and a predicted temperature based on counter 4 (via the thermal RC circuit model 121).

A second circuit, such as the thermal mitigation function module 320, is configured to schedule a thermal mitigation function based on the predicted temperature. The thermal mitigation function module 320 may cause the processor 100 to perform various thermal mitigation functions based on the predicted temperature determined by the temperature prediction module 310. The thermal mitigation functions may include, for example, lowering the operating voltage of a core, throttling or reducing the operating frequency of a core, and/or collapsing the power of the core.

Aspects of the disclosure provide that the temperature prediction module 310 predict a temperature of the location 110 in a forward loop. Such predictive determination of temperatures allows the thermal mitigation function module 320 to schedule the thermal mitigation functions hundreds or even thousands clock cycles ahead, and therefore, more measured and effective thermal mitigation functions may be performed to address the hot spots (e.g., locations where the thermal profiles are projected to exceed a threshold).

In one implementation, hot spot information (e.g., the predicted temperatures exceeding certain temperature limits) is stored in the hot spot location memory 340. The hot spot location memory 340 may include registers or other types of memories. Moreover, the hot spot information may store the predicted temperatures with location information (e.g., x and y coordinates of the processor 100). In one implementation, the temperature prediction module 310 may be configured to amend or update the predict temperatures and the hot spot information stored in the hot spot location memory 340 in response to an updating of the predicted temperatures.

In one implementation, the thermal mitigation function module 320, based on the predicted temperatures from the temperature prediction module 310 and/or the hot spot information from the hot spot location memory 340, may schedule and execute the aforementioned thermal mitigation measures (voltage scaling, frequency adjustment, etc.) for a predicted hot spot in the future. In one example, the thermal mitigation function module 320 may include a circuit configured to schedule a thermal mitigation function based on the predicted temperatures. In one example, the thermal mitigation function module 320 may executed the scheduled thermal mitigation functions at the scheduled times.

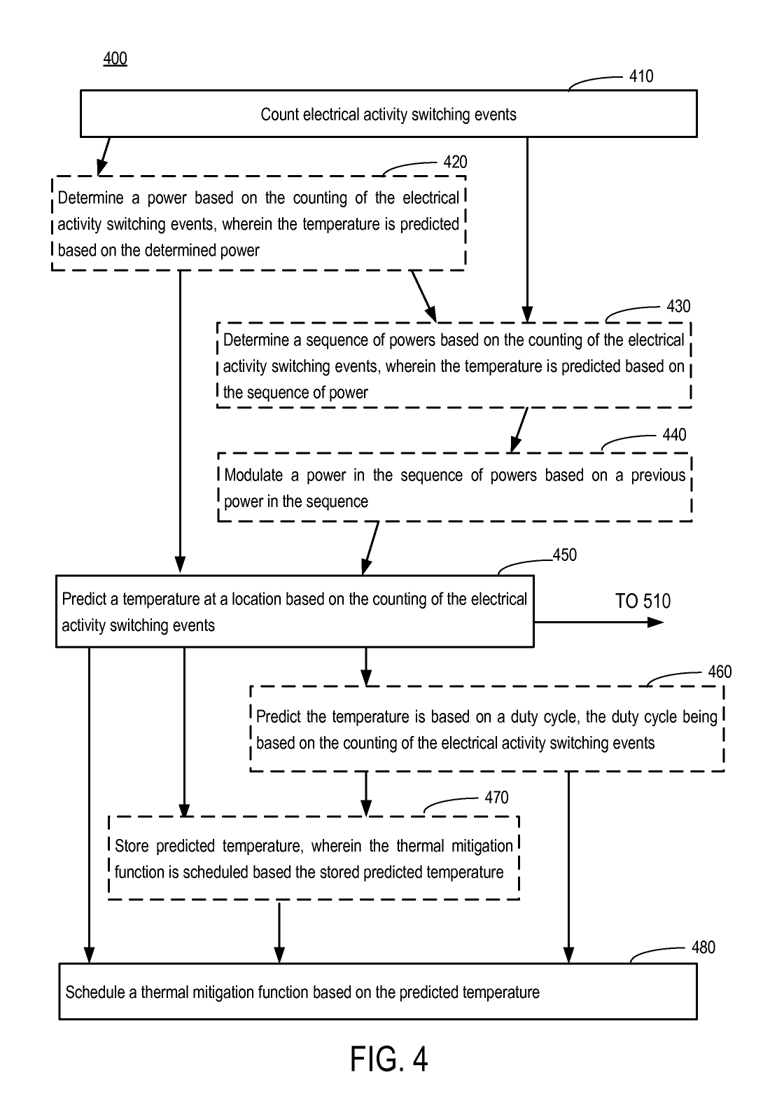

FIG. 4 is a flow chart of an exemplary embodiment for scheduling a thermal mitigation function. The steps shown in dotted line may be optional. The steps may be performed by an apparatus such as a cell phone incorporating the processor 100 or the processor 100. At 410, electrical activity switching events are counted. For example, referring to FIG. 1, one of the counters 1-10 counts the ON or OFF events of a core in the time period. At 420, a power is determined based on the counting of the electrical activity switching events. The temperature is predicted based on the determined power. For example, the temperature prediction module 310 may determine a power P(T) utilizing the algorithm presented above, and to predict a temperature based on the power P(T).

At 430, a sequence of powers is determined based on the counting of the electrical activity switching events. The temperature is predicted based on the sequence of power. For example, the temperature prediction module 310 may determine a sequence of powers Pₙ utilizing the algorithm presented above, and to predict a temperature based on the sequence of powers Pₙ. At 440, a power in the sequence of powers is modulated based on a previous power in the sequence. For example, the temperature prediction module 310 may determine modulating factor M for a Pₙ in the sequence. The modulating factor M may be based on a previous Pₙ in the sequence.

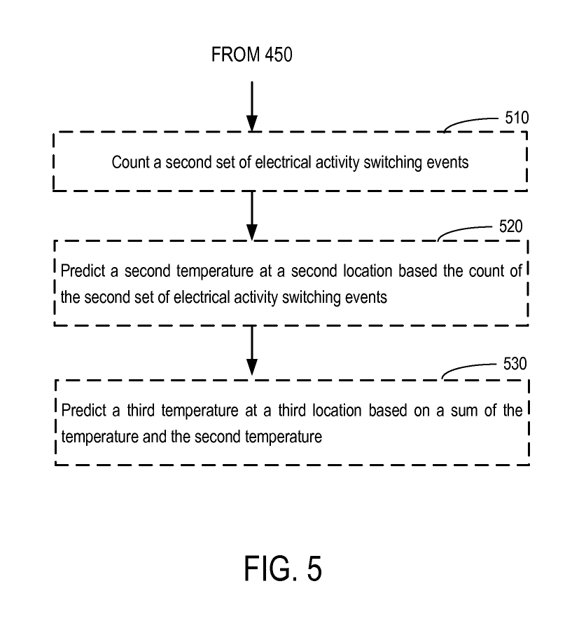

At 450, a temperature is predicted at a location based on the counting of the electrical activity switching events. For example, referring to FIG. 1, the temperature prediction module 310 may predict a temperature at the location of counter 3 based on the count from counter 3. In one implementation, the flow may go to 510 of FIG. 5. At 460, the temperature is predicted based on a duty cycle, the duty cycle being based on the counting of the electrical activity switching events. For example, the temperature prediction module 310 may predict a temperature utilizing the algorithm presented above, which incorporates the duty cycle of a core based on a count of the electrical activity switching events (e.g., the activity counter R1 in the algorithm, which corresponds to the counters 1-10).

At 470, the predicted temperature is stored. The thermal mitigation function is scheduled based the stored predicted temperature. At 480, a thermal mitigation function is scheduled based on the predicted temperature. For example, the hot spot location memory 340 may store the predicted hot spots (e.g., locations where the associated predicted temperatures exceed a temperature threshold) with location information. The thermal mitigation function module may schedule and execute a thermal mitigation function based on the stored hot spot information.

FIG. 5 is another flow chart of an exemplary embodiment for scheduling a thermal mitigation function. At 510, which may be from step 450, a second set of electrical activity switching events is counted. At 520, a second temperature at a second location is predicted based the counting of the second set of electrical activity switching events. For example, referring to FIG. 1, the counter 4 counts electrical activity switching events of the associated core. The temperature prediction module 310 may predict a temperature associate with the core of counter 4 utilizing the algorithm presented above. At 530, a third temperature at a third location is predicted based on a sum of the temperature and the second temperature. For example, referring to FIG. 1, the temperature prediction module 310 may predict a temperature at location based on a linear sum of a temperature of counter 3 and a temperature of counter via thermal RC circuit models 120 and 121.

Moreover, the exemplary embodiments presented above provide the means for each of the steps of the flow charts of FIGS. 4 and 5. For example, one of the counters 1-10 provides means for counting electrical activity switching events. The temperature prediction module 310 provides means for means for predicting a temperature at a location based on a count of the electrical activity switching events. The thermal mitigation function module provides means for scheduling a thermal mitigation function based on the predicted temperature. The hot spot location memory 340 provides means storing the predicted temperature. A second counter of the counters 1-10 provides means for counting a second set of electrical activity switching events.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus, comprising:
a plurality of counters configured to count electrical activity switching events of cores;
a first circuit configured to predict a temperature at a location based on counts of at least one of the plurality of counters; and
a second circuit configured to schedule a thermal mitigation function based on the predicted temperature.

2. The apparatus of claim 1, wherein the first circuit is further configured to determine a power based on the counts of the at least one of the plurality of counters, the predicted temperature being based on the determined power.

3. The apparatus of claim 1, wherein the first circuit is further configured to predict the temperature based on a duty cycle of a core among the cores, which is based on the counts of the at least one of the plurality of counters associated with the core.

4. The apparatus of claim 1, wherein the first circuit is configured to predict the temperature via a convolution function.

5. The apparatus of claim 1, wherein the first circuit is further configured to determine a sequence of powers based on the counts of at least one of the plurality of counters, the predicted temperature being based on the sequence of powers.

6. The apparatus of claim 5, wherein the first circuit is configured to modulate a power in the sequence of powers based on a previous power in the sequence of powers.

7. The apparatus of claim 1, wherein the first circuit is configured to predict the temperature further based on a leakage power.

8. The apparatus of claim 1, further comprising a memory configured to store the predicted temperature, wherein the second circuit is configured to schedule the thermal mitigation function based the predicted temperature stored in the memory.

9. The apparatus of claim 8, wherein the first circuit is configured to predict a second temperature at a second location based a second one of the plurality of counters.

10. The apparatus of claim 9, wherein the first circuit is configured to predict a third temperature at a third location based on a sum of the temperature and the second temperature.

11. A method for scheduling thermal mitigation functions, comprising:
counting electrical activity switching events;
predicting a temperature at a location based on the counting of the electrical activity switching events; and
scheduling a thermal mitigation function based on the predicted temperature.

12. The method of claim 11, further comprising determining a power based on the counting of the electrical activity switching events, wherein the predicting the temperature is based on the determined power.

13. The method of claim 11, wherein the predicting the temperature is based on a duty cycle, which is based on the counting of the electrical activity switching events.

14. The method of claim 11, wherein the predicting the temperature comprises a convolution function.

15. The method of claim 11, further comprising determining a sequence of powers based on the counting of the electrical activity switching events, wherein the predicting the temperature is based on the sequence of powers.

16. The method of claim 15, further comprising modulating a power in the sequence of powers based on a previous power in the sequence of powers.

17. The method of claim 11, wherein predicting the temperature is further based on a leakage power.

18. The method of claim 11, further comprising storing the predicted temperature, wherein the scheduling the thermal mitigation function is based the stored predicted temperature.

19. The method of claim 18, further comprising:
counting a second set of electrical activity switching events;
predicting a second temperature at a second location based the counting of the second set of electrical activity switching events.

20. The method of claim 19, further comprising predicting a third temperature at a third location based on a sum of the temperature and the second temperature.

21. An apparatus, comprising:
means for counting electrical activity switching events;
means for predicting a temperature at a location based on a count of the electrical activity switching events; and
means for scheduling a thermal mitigation function based on the predicted temperature.

22. The apparatus of claim 21, wherein the means for predicting the temperature is further configured to determining a power based on the count of the electrical activity switching events and to predict the temperature based on the determined power.

23. The apparatus of claim 21, wherein the means for predicting the temperature is further configured to predict the temperature is based on a duty cycle, which is based on the count of the electrical activity switching events.

24. The apparatus of claim 21, wherein the means for predicting the temperature is configured to perform a convolution function.

25. The apparatus of claim 21, wherein the means for predicting the temperature is further configured to determine a sequence of powers based on the count of the electrical activity switching events and to predict the temperature based on the sequence of powers.

26. The apparatus of claim 25, wherein the means for predicting the temperature is further configured to modulate a power in the sequence of powers based on a previous power in the sequence of powers.

27. The apparatus of claim 21, wherein the means for predicting the temperature is further configured to predict the temperature further based on a leakage power.

28. The apparatus of claim 21, further comprising means storing the predicted temperature, wherein the means for scheduling the thermal mitigation function is configured to schedule the thermal mitigation function based the stored predicted temperature.

29. The apparatus of claim 28, further comprising:
means for counting a second set of electrical activity switching events, wherein the means for predicting the temperature is further configured to predict a second temperature at a second location based a count of the second set of electrical activity switching events.

30. The apparatus of claim 29, wherein the means for predicting the temperature is further configured to predict a third temperature at a third location based on a sum of the temperature and the second temperature.
